(19) United States
(12) Patent Application Publication
(10) Pub. No.: US 2010/0224497 A1
(43) Pub. Date: Sep. 9, 2010

(54) DEVICE AND METHOD FOR THE EXTRACTION OF METALS FROM LIQUIDS

(76) Inventors: David Livshits, San Francisco, CA (US); Lester Teichner, Chicago, IL (US)

Correspondence Address: VEDDER PRICE P.C., 222 N. LASALLE STREET, CHICAGO, IL, 60601, US

(21) Appl. No.: 12/682,174

(22) PCT Filed: Oct. 9, 2008
(86) PCT No.: PCT/US08/79312

§ 371 Date: Apr. 8, 2010

Related U.S. Application Data
(60) Provisional application No. 60/978,924, filed on Oct. 10, 2007.

(51) Int. Cl. C02F 1/461; C25B 9/00; C25B 11/02; C25D 21/12

(52) U.S. Cl. 205/82; 204/252; 204/282; 205/750

(57) ABSTRACT

A volume-porous electrode is provided which increases effectiveness and production of electrochemical processes. The electrode is formed of a carbon, graphitic cotton wool, or from carbon composites configured to permit fluid flow through a volume of the electrode in three orthogonal directions. The electrode conducts an electrical charge directly from a power source, and also includes a conductive band connected to a surface of the electrode volume, whereby a high charge density is applied uniformly across the electrode volume. Apparatus and methods which employ the volume-porous electrode are disclosed for removal of metals from liquid solutions using electroextraction and electro-coagulation techniques, and for electrochemical modification of the pH level of a liquid.

### CROSS-REFERENCE TO RELATED APPLICATIONS

The present application claims benefit of U.S. Provisional Application No. 60/978,924, filed on Oct. 10, 2007. In addition, the present application is related to copending PCT Patent Application No. ______ (attorney docket number 30029-004WO1). The disclosures of said provisional application and PCT application, including the specification, claims and figures, are incorporated herein by reference.

### TECHNICAL FIELD

The present invention is directed to electrochemical process equipment, systems and methods for treatment and cleaning of liquid solutions.

### BACKGROUND OF THE INVENTION

Obtaining clean water from liquids contaminated by discharge of industrial effluents as well as other anthropogenic activities and natural processes is of great social and economic importance. With particular attention to industrial effluents, contaminated liquids are produced as by-products of manufacturing processes by many industries. Such contaminated liquids are typically water solutions containing dissolved ions of heavy metals, and result, for example, from the washing and/or rinsing of items after electrolytic coating (galvanic) and other similar processes.

Use of electrochemical processes in the processing and treatment of contaminated liquid solutions is well known. The concentration of ions of heavy metals in water solutions can substantially influence the choice of technology, or the combination of technologies, used for the treatment and clearing of these water solutions. In an electroextraction process, a current is passed from an inert anode through a liquid solution containing one or more metals so that the metal is extracted as it is deposited in an electroplating process onto the cathode. In an electro-coagulation process, precipitation of heavy metals (ions) from a liquid solution is achieved by adding ions of opposite charge to the liquid solution via an electrode pair. This has the effect of facilitating agglomeration or coagulation of the metals, resulting in separation from the liquid.

In many conventional electrolytic system designs for the processing and treatment of liquids, which are typically water solutions containing heavy metals, several problems exist. For example, electrode function often deteriorates due to increasing resistance from oxidation of the electrode working surfaces. As further examples, the contacts that connect the cables to an electric source often experience galvanic destruction, and pollution of the treated liquid may occur due to the destructive by-products of the metal contacts and to the deterioration of the electrodes. Moreover, due to the small active area of the working surface of conventional electrodes the process rate can sometimes be slow, and a low speed of extraction of metals from liquid solutions can result in inefficient and costly processes. In some designs, there are limitations on the ability to extract metals from liquids with high acidity and alkalinity.

Further known disadvantages of the use of electrochemical processes in the processing and treatment of liquid solutions are that they sometimes require the use of ancillary process steps, as for example a sedimentation bath, which in itself may have low efficiency and require significant floor space. Such electrochemical processes often produce significant levels of toxic waste, resulting in significant costs for recycling, and often also require intermediate clearing operations when conducting multistage clearing of the same volumes of a liquid, reducing process efficiency.

### SUMMARY

The present disclosure is directed to a number of aspects of electrochemical process equipment, systems and methods for treatment and cleaning of liquid solutions of heavy metals, regardless of concentration of metals within the liquid, regardless of liquid pH, and under conditions where the metal ions are free or bound up with other chemicals. In some aspects, an electrode includes a porous electrode volume, and is made of from carbon, graphitic cotton wool, or from carbon composites. In some aspects, the configuration of the volume-porous electrode determined by the requirements of the type of process used, and by the characteristics of the liquid to be processed. In some aspects, the electrode is formed of a plurality of folded and stacked carbon carbon wool plates to create a porous electrode with a large working volume. In other aspects, the electrode is formed in a cylindrical shape and coated with the carbon carbon wool fabric. Examples of novel symmetric and asymmetric electrode pair cell structures are provided which advantageously employ the volume-porous electrodes.

A volume-porous electrode permits liquid to flow through the volume of the electrode. For example, liquid may flow through the volume in a first direction, in a second direction perpendicular to the first direction, and in a third direction perpendicular to both the first and second directions. A volume-porous electrode allows three-dimensional flow, as compared to the conventional “surface-porous” electrode (FIG. 12) in which the material permits very limited flow in a direction perpendicular to a surface of the electrode and substantially directs flow in a direction parallel to the surface, and the conventional “area-porous” electrodes (FIGS. 13 and 14) in which flow is permitted through the electrode in one dimension, that is, in a direction perpendicular to a surface thereof.

Some aspects of the present disclosure are also directed to descriptions of electrochemical process equipment and methods for treatment and cleaning of liquid solutions of heavy metals which use the above described electrodes. In some examples, apparatus and methods are disclosed for removal of metals from liquid solutions using electroextraction and electro-coagulation techniques.

In addition, apparatus and methods are disclosed for electrochemical modification of the pH level of a liquid. In some examples, these apparatus and methods achieve substantively complete separation of metals from a liquid solution and/or desired modification of liquid pH regardless of concentration of metals within the liquid, regardless of initial liquid pH, and under conditions where the metal ions are free or bound up with other chemicals.

In some aspects, the apparatus and methods disclosed herein apply electrochemical techniques in combination with novel electrode and electrode cell structures. In some examples, the application of symmetric and asymmetric variants of the design of the electrode cells is dependent upon the specific requirements of the desired electrochemical process and on the character and type of liquids to be processed, with particular application to metallic water solutions.

In some aspects, a porous volumetric electrode is provided, the electrode including a volume, and may be adapted to permit fluid flow through the volume in a first direction, and in a second direction perpendicular to the first direction. In some embodiments, the electrode is further adapted to permit fluid flow through the volume in a third direction perpendicular to the first and second directions, and may be formed of an electrically conductive fabric. In some embodiments, the electrode may be formed of a flexible, electrically conductive fabric that has been pressed into a plate shape and folded back on itself at least once to obtain a structure having the volume. In some embodiments, the electrode further includes an electrically conductive, porous, elastic band, wherein the band circumferentially surrounds the volume of the electrode.

In some aspects, an electrochemical reactor for processing a liquid solution is provided. The reactor includes a housing, the housing including a liquid inlet through which the liquid is directed into the housing, and a liquid outlet; an electrically neutral membrane which partitions the housing into a first well and a second well, the membrane configured to electrically insulate a contents of the first well from a contents of the second well; a first electrode comprising a first volume and extending into the first well; and a second electrode comprising a second volume and extending into the second well. The first and second volumes may be configured to permit fluid flow in a first direction, and in a second direction perpendicular to the first direction. In some embodiments, the first volume is substantially the same as a volume of the first well, and the second volume is substantially the same as a volume of the second well. In addition, in some embodiments, the first volume is substantially the same as the second volume. In other embodiments, the first volume is greater than the second volume. In some embodiments, the first electrode and the second electrode are each formed of an electrically conductive fabric.

In some embodiments, the first and second electrodes are adapted to be connected to a sources of electric potential, such that when a positive electrical potential is applied to the first electrode and a negative electrical potential is applied to the second electrode, a substantially uniform current density is provided across the respective first and second volumes, whereby when the liquid passes from the liquid inlet to the liquid outlet, an electrochemical reaction takes place in which metals in the liquid are deposited on at least one of the conductive members, and liquid exiting the liquid outlet is substantially free of metals.

In some embodiments, the first electrode and the second electrode are each formed of coal carbon wool pressed into a plate. The plate includes plural folds such that the plate is configured into plural stacked layers, and the plural stacked layers are wrapped in an electrically conductive band that surrounds, and is electrically conductive with, the outer periphery of the electrically conductive fabric.

In some aspects, a method is provided for extraction of metals from a liquid that includes one or more metals in solution. In some examples, the method uses an extraction device that includes an electrode cell, and a first electrode and a second electrode disposed within the electrode cell. The first and second electrodes are physically and electrically separated by a porous, electrically neutral membrane. The method may include the following method steps:

Connecting the active working volume and an active working surface of the first electrode to a source of constant positive electric potential.

Connecting the active working volume and an active working surface of the second electrode to a source of constant negative electric potential.

Applying a constant electric potential to the electrode cell such that at least 90 percent of a respective active working volume of the electrodes of the electrode cell is provided with a source of substantially constant electric potential.

Creating a directed stream of the liquid in an entrance channel of the electrode cell.

Permitting the stream to flow within the active working volume of the first electrode.

Pressing the stream from the active working volume of the first electrode through the membrane and into the active working volume of the second electrode.

Permitting the stream to flow within the active working volume of the second electrode.

Outputting a stream of a processed liquid from the active working volume of the second electrode via an exit channel of the electrode cell.

In the method, a current density may be created that is substantially uniform across the respective active working volumes of the first and second electrodes, and, in some examples, is capable of producing a high-speed process of electro-deposition of metal in the active working volume of the second electrode.

In some embodiments, the liquid comprises a water solution. In some embodiments, the step of applying a constant electric potential to the electrode cell includes contacting at least 95 percent of the respective active working volume of the electrodes of the electrode cell. In other embodiments, the step of applying a constant electric potential to the electrode cell includes contacting substantially the entire respective active working volume of the electrodes of the electrode cell. In still other embodiments, the step of connecting the active working volume includes connecting the entire active working volume and the entire active working surface of the respective first and second electrodes to the source of constant electric potential.

In some embodiments, the step of outputting a stream of a liquid from the active working volume of the second electrode may include outputting a substantially metal-free stream of a liquid. In some embodiments, the extraction device further comprises a magnetic resonance sensor, and the method further comprises the step of determining the density of the second electrode using the magnetic resonance sensor. In some embodiments, density of the active working volume of the second electrode may be determined based on measured electrical resistance of the second electrode. In some embodiments, the extraction device further includes magnetic resonance sensors, and the method may further include the step of: Providing remote control of the electrochemical processes, wherein the remote control comprises uses the magnetic resonance sensors to measure a level of electric resistance of the liquid before electrochemical processing.

In some embodiments, the extraction device may further include magnetic resonance sensors, and the method may further include the steps of: Using the magnetic resonance sensors to monitor a level of electrical conductivity in the liquid before and after processing; and regulating the electrical parameters of the electro-deposition processes based on the active working surface and the acting working volume of the second electrode and the metals contained in the liquid based on the monitored level of electrical conductivity.

In some aspects, a device is provided for electrolytic extraction of metals from a liquid that includes one or more metals in solution. In some examples, the device includes a first electrode and a second electrode, and an electrically neutral, porous membrane disposed between the first and second electrodes. The device may also include a source of substantially constant positive electric potential connected to the first electrode, and a source of substantially constant negative electric potential connected to the second electrode. The device may include a first porous, elastic, nonmetallic woven contact disposed to cover at least a portion of an external surface of the first electrode, the first contact being electrically connected to the source of the constant positive electric potential, and a second porous, elastic, nonmetallic woven contact disposed to cover at least a portion of an external surface of the second electrode, the second contact being electrically connected to the source of the constant negative electric potential. In addition, the device may include an input device configured to input the liquid solution into a working volume of the first electrode, and an output device configured to output a processed liquid from a working volume of the second electrode.

In some embodiments, the liquid comprises a water solution. In some embodiments, the membrane includes a filtering fabric including polypropylene strings.

In some aspects, a system is provided for extraction of metals from a liquid to be processed, in which the liquid to be processed includes one or more metals in solution. The system may include a device for electrolytic extraction of metals from the liquid to be processed. The device may include volume-porous electrode, a first subsystem configured to input the liquid to be processed into the device for electrolytic extraction, and a second subsystem configured to output a processed liquid from the device.

In some embodiments, the device may further include a third subsystem configured to do one or more of gathering, storing, and re-processing the processed liquid, and a fourth subsystem configured to do one or more of gathering and accumulating the liquid to be processed. In some embodiments, the liquid to be processed comprises a water solution. In some embodiments, the volume-porous electrodes are volume-porous electrodes configured for processing a particular type of liquid. In some embodiments, the device for electrolytic extraction comprises at least one module, the at least one module including a plurality of electrolytic cells, each cell including a pair of volume-porous electrodes.

In some aspects, a symmetric electrode cell is provided for electrochemically processing a liquid solution. The symmetric electrode cell may include a first volume-porous electrode connected to a first source of constant electric potential, and a second volume-porous electrode connected to a second source of constant electric potential. The first and second electrodes may have substantially identical dimensions with respect to respective active working surfaces and respective active working volumes, and an electrically-neutral, liquid-porous membrane may be disposed between the first and second electrodes such that the first and second electrodes are symmetrically located on opposite sides of the membrane. A housing of the symmetric electrode cell may be provided which has a first aperture in a bottom portion of the housing that opens so as to face the first electrode, the first aperture permitting input of a liquid to be processed into the housing. The housing may also have a second aperture in a top portion of the housing that opens so as to face the second electrode, the second aperture permitting output of the liquid after processing. In addition, a first electrically conductive, non-metallic, flexible, elastic, porous fabric member may be electrically connected with an external surface of the first electrode and further electrically connected with the first source of constant electric potential, and a second electrically conductive, non-metallic, flexible, elastic, porous fabric member may be electrically connected with an external surface of the second electrode and further electrically connected with the second source of constant electric potential. In some examples, the first source of constant electric potential has a polarity opposed to that of the second source of constant electric potential.

In some embodiments, the first and second fabric members are made in the form of a band.

In some aspects, an electrode cell is provided that may include a first electrode comprising a first porous volume, a second electrode comprising a second porous volume, and an electrically-neutral member comprising a liquid-porous membrane. The electrode cell may also include a first elastic current contact comprising a nonmetallic, current-carrying and liquid-porous fabric. The first elastic current contact may be electrically connected to both an external surface of the first electrode and to a first output of a source of constant electric potential. The electrode cell may also include a second elastic current contact comprising a nonmetallic, current-carrying and liquid-porous fabric. The second elastic current contact may be electrically connected to both an external surface of the second electrode and to a second output of the source of constant electric potential, the second output of the source of constant electric potential having an opposite polarity from the first source of constant electric potential. In addition, the electrode cell may include a housing formed of dielectric material. The housing may include an introduction aperture in a bottom part of a housing sidewall and an output aperture in a top part of the housing sidewall, the input and output apertures located so as to be spaced apart in a circumferential direction of the housing sidewall.

In some embodiments, the first volume may be substantially the same as the second volume. In other embodiments, the first volume may be substantially different from the second volume.

In some aspects, an electro-coagulation device is provided. The device may include a housing comprising a ceiling member and a floor member. The housing may be configured to store a liquid to be processed in a storage space between the ceiling member and the floor member. The device may include at least one electrode cell, the electrode cell including a first electrode, the first electrode configured to be connected to a source of positive electric potential and being formed of a consumable material, and a second electrode, a portion of the second electrode being disposed coaxially within the first electrode, the second electrode configured to be connected to a source of negative electric potential and being formed of a non-consumable material. An inter-electrode space may be provided between an outer surface of the second electrode and an inner surface of the first electrode in the vicinity of the coaxially disposed portion of the second electrode. The first electrode may be mounted to the ceiling member so as to permit vertical adjustment of its position relative to the ceiling member, and extends downward from the ceiling member into the storage space. The second electrode may be mounted to the floor member so as to permit vertical adjustment of its position relative to the floor member, and extend upward from the floor member into the storage space, and the relative vertical adjustments of the first and second electrodes permit adjustment of the size of the inter-electrode space.

In some embodiments, the electro-coagulation device may further include a first contact clamp providing an electrical connection between the first electrode and the source of positive electric potential, and a second contact clamp providing an electrically connection between the second electrode and the source of negative electric potential. The first and second contact clamps may reside outside the housing.

The electro-coagulation device may in clued one or more of the following features: The coaxially arranged first and second electrodes can be independently positionally adjusted in at least two directions. The first and second electrodes may be in the form of hollow cylinders. The second electrode may be comprised of a chemically inert material so as to be reusable. The device may further comprise a contact clamp disposed on the first electrode, the contact clamp serving to maintain the position of the first electrode with respect to the housing, the contact clamp configured to be rotatable about a circumference of, and moveable along an axis of, the first electrode. The device may further comprise a contact clamp disposed on the second electrode, the contact clamp serving to maintain the position of the second electrode with respect to the housing, the contact clamp configured to be rotatable about a circumference of, and moveable along an axis of, the second electrode. The first electrode may be formed of a material selected from the group comprising aluminum, an aluminum alloy, iron, and low carbon steel. The second electrode may be formed of a high alloy stainless steel comprising alloying impurities being not less than 25 percent thereof. The second electrode may be formed of one of titanium and a titanium alloy. The second electrode may be formed of a composite nonmetallic material. The second electrode may be formed of a chemically inert metal having an outer protective current-carrying covering. The second electrode may be formed of titanium and has an outer protective coating of an oxide of ruthenium.

In some embodiments, a method is provided for performing electrochemical coagulation using at least one coaxial electrode cell. In the method, the cell may include a housing comprising a ceiling member and a floor member. The housing may be configured to store a liquid to be processed in a storage space between the ceiling member and the floor member. The at least one electrode cell may include a first hollow electrode, the first electrode configured to be connected to a source of positive electric potential and being formed of a consumable material, and a second hollow electrode, a portion of the second electrode being disposed coaxially within the first electrode, the second electrode configured to be connected to a source of negative electric potential and being formed of a non-consumable material. An inter-electrode space may be provided between an outer surface of the second electrode and an inner surface of the first electrode in the vicinity of the coaxially disposed portion of the second electrode. In the cell, the first electrode may extend downward from the ceiling member into the storage space such that a lower end of the first electrode is received within an interior space of a cup member disposed on the floor member, and the second electrode may extend upward from the floor member into the storage space. The method may include the following method steps:

Complete an electrical contact of the first electrode to a source of constant positive electric potential, and of the second electrode to a source of constant negative electric potential.

Create a directed stream of a liquid to be processed between the cup member and the lower end of the anode.

Form an ascending stream of the liquid through the inter-electrode space.

Form a descending stream of the liquid through an internal cavity of the second electrode, and output a stream of a precipitating liquid from internal cavity of the second electrode.

The method may include one or more of the following features: The coaxially arranged first and second electrodes may be configured to allow relative axial motion to compensate for a reduction of the length of the inter-electrode space due to deterioration of the anode. During coagulation both internal and external surfaces of the first and second electrodes may be used. In some examples an external surface of the first electrode may be used for preliminary activation of a liquid, and an internal surface of the first electrode may be used for formation of the inter-electrode space. In some examples, external surface of the second electrode may be used for formation of inter-electrode space, and an internal surface of the second electrode used as a conduit for removal of a liquid with coagulant from the inter-electrode space.

In some aspects, an apparatus is provided for electrochemical alteration of pH of a liquid. The apparatus may include at least one asymmetric electrode cell, the electrode cell comprising volume-porous electrodes. The apparatus may include an accumulation device configured to gather and store the liquid, the accumulation device comprising a system of vessels, a collection device configured to collect the liquid from the accumulation device and deliver the liquid into the at least one asymmetric cell, and a delivery system. In some examples, the delivery system is configured to gather altered liquid from the at least one asymmetric cell and deliver the altered liquid to one of an output storage device for storage of the altered liquid, and the accumulation device for re-processing of the altered liquid.

The apparatus may further include one or more of the following features: The liquid comprises a water solution. The configuration of the volume-porous electrodes is determined based on the characteristics of the liquid. The asymmetric electrode cell comprises a first volume-porous electrode electrically connected to a source of positive electric potential and a second volume-porous electrode electrically connected to a source of negative electric potential, the first electrode having a greater volume than the second electrode, such that the level of acidity of the altered liquid is increased. In some embodiments, the level of acidity of the altered liquid is increased to the extent that the altered liquid is disinfected. The asymmetric electrode cell comprises a first volume-porous electrode electrically connected to a source of positive electric potential and a second volume-porous electrode electrically connected to a source of negative electric potential, the second electrode having a greater volume than the first electrode, such that the level of alkalinity of the altered liquid is increased.

In some aspects, an asymmetric electrode cell is provided for electrochemical processing of a liquid. The asymmetric electrode cell may include an electrically-neutral, liquid-porous membrane; a first volumetric, porous electrode electrically connected to a source of positive constant electric potential, and a second volumetric, porous electrode connected to a source of negative constant electric potential, the first and second electrodes being located on opposite sides of the membrane. An active working surface and active working volume of the first electrode differs from an active working surface and active working volume of the second electrode. The asymmetric electrode cell may further include a first electrically-conductive fabric member comprising an electrical connection with both an external surface of the first electrode and with the positive output of the source of constant electric potential, and a second electrically-conductive fabric member comprising an electrical connection with an external surface of the second electrode and with the negative output of the source of constant electric potential. The asymmetric electrode cell may further include a housing in which the first and second electrodes are disposed. In some examples, the housing includes a first aperture formed in a bottom part of the housing that opens facing the first electrode, the first aperture permitting input of the liquid into the housing, a second aperture formed in a top part of the housing that opens facing the first electrode, the second aperture permitting output of the liquid after processing, a third aperture formed in a bottom part of the housing that opens facing the second electrode, the third aperture permitting input of the liquid to be processed, and a fourth aperture formed in a top part of the housing that opens facing the second electrode, the fourth aperture permitting output of the liquid after processing.

In some embodiments, the first and second fabric members are formed of a material that is non-metallic, flexible, elastic, and liquid-porous. In some embodiments, the first and second fabric members are made in the form of a band. In some embodiments, the liquid comprises a water solution.

In some aspects, a method is provided for altering the pH level within a liquid solution using an asymmetric electrode cell. The asymmetric cell may include an electrically-neutral, liquid-porous membrane, a first porous volumetric electrode electrically connected to a source of positive constant electric potential, and a second volume-porous electrode connected to a source of negative constant electric potential, the first and second electrodes being located on opposite sides of the membrane. An active working surface and active working volume of the first electrode differs from an active working surface and active working volume of the second electrode. The asymmetric cell may include a housing in which the first and second electrodes are disposed. The housing may include a first aperture formed in a bottom part of the housing that opens facing the larger electrode, the first aperture permitting input of the liquid into the housing, a second aperture formed in a top part of the housing that opens facing the larger electrode, the second aperture permitting output of the liquid after processing, a third aperture formed in a bottom part of the housing that opens facing the smaller electrode, the third aperture permitting input of the liquid to be processed, and a fourth aperture formed in a top part of the housing that opens facing the smaller electrode, the fourth aperture permitting output of the liquid after processing. The method may include the following method steps:

Determining the desired level of pH for the output liquid.

Completing an electrical contact of the electrodes the asymmetric cell to a source of constant electric potential such that an electric charge is conducted to the active working volume and active working surfaces of the first and second electrodes.

Applying a constant electric potential on the first and second electrodes based on the desired level of pH for the output liquid, such that an increased acidity of a liquid to be treated is obtained by connecting the larger electrode of the first and second electrodes to a source of positive potential, and connecting the smaller electrode of the first and second electrodes to a source of negative potential, and an increased alkalinity of a liquid to be treated is obtained by connecting the larger electrode of the first and second electrodes to a source of negative potential, and connecting the smaller electrode of the first and second electrodes to a source of positive potential.

Creating a directed input stream of a liquid to be processed in the first and third apertures of the cell.

Forming an ascending stream of the liquid through the respective volumes of the charged electrodes.

Electrically pressing liquids from the ascending stream in the charged larger electrode.

Outputting a first stream of liquid from the active working volume of the larger charged electrode via the second aperture, the first stream having the desired pH characteristics.

Outputting a second stream of liquid from the active working volume of the smaller, oppositely charged electrode via the fourth aperture, the second stream having an undesirable pH characteristic.

In some embodiments, the method comprises the further step of directing the second stream back into the input stream of liquid so as to recycle the second stream through the asymmetric electrolytic cell. In some embodiments, the cell further comprises at least one magnetic resonance sensor, and wherein the method comprises the further step of remotely controlling of alteration of the pH level of the liquid by using the at least one magnetic resonance sensor to measure a level of electric resistance of the liquid before electrochemical processing.

Modes for carrying out the aspects of the invention are explained below by reference to embodiments of the aspects shown in the attached drawings. The above mentioned aspects of the invention, other aspects, characteristics and advantages will become apparent from the detailed description of the embodiments presented below in conjunction with the attached drawings.

### BRIEF DESCRIPTION OF THE DRAWINGS

FIG. 1 is a side sectional view of a symmetric electroextraction cell.

FIG. 2 is a side sectional view of the electroextraction cell of FIG. 1, showing the flow path of a of liquid through the cell.

FIG. 3 is a side sectional view of a portion of a module.

FIG. 4 is a side sectional view of an isolated external tank.

FIG. 5 is a partially schematic side sectional view of the module of FIG. 3.

FIG. 6 is a top perspective view of the module of FIG. 3.

FIG. 7 is a schematic illustration of a system for electroextraction.

FIG. 8 is a side sectional view of an electro-coagulation cell.

FIG. 9 is a perspective view of a contact clamp used in the electro-coagulation cell of FIG. 8.

FIG. 10 is a side sectional view of an asymmetric electrode cell.

FIG. 11 is a side sectional view of the electrode cell of FIG. 10, showing the flow path of a liquid through the cell.

FIG. 12 is a schematic illustration of fluid flow across a conventional electrode.

FIG. 13 is a schematic illustration of fluid flow through a conventional mesh electrode.

FIG. 14 is a schematic illustration of fluid flow through a conventional perforated electrode.

FIG. 15 is a schematic illustration of three dimensional fluid flow through a volume-porous electrode.

FIG. 16 is schematic view of a system for altering the pH level of a liquid.

FIG. 17 is a side sectional view of a symmetric electroextraction cell.

FIG. 18 is an end view of the symmetric electroextraction cell.

FIG. 19 is a first perspective view of the symmetric electroextraction cell.

FIG. 20 is a second perspective view of the symmetric electroextraction cell.

FIG. 21 is a perspective view of an isolated conductive band.

### DESCRIPTION

Apparatus, systems and methods for electrochemically processing liquids are presented herein. In particular, electrochemical cells employing volume-porous electrodes formed of flexible, conductive fabric are described. The specific configuration of the volume-porous electrode can be determined by the requirements of the type of process used, and of the characteristics of the liquid to be processed. The electrode structure permits generation of a uniformly high current density across the electrode working volume. The apparatus and methods are described for three illustrative electrochemical processes with reference to the figures, but the inventive concepts disclosed herein are not limited thereto.

### Electroextraction (Electrochemical Deposition)

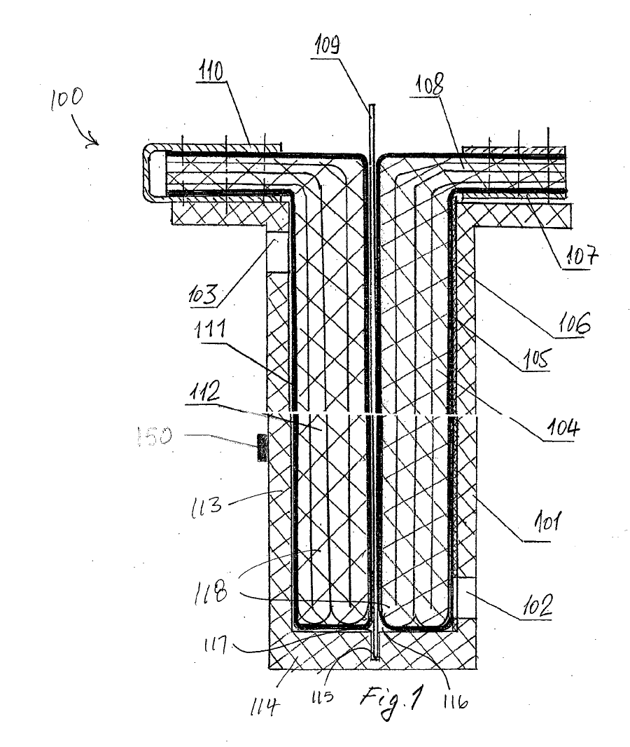

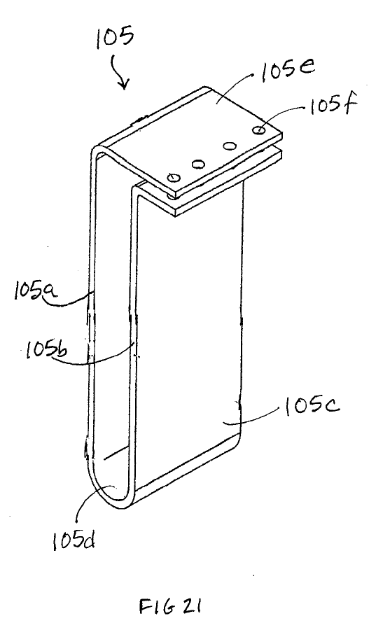

In some embodiments, electroextraction of metals from a liquid solution is achieved using a symmetric electroextraction cell 100. As seen in FIG. 1 and FIGS. 17-20, the electroextraction cell 100 includes a housing 101. The housing 101 includes closed sidewalls 113 and a bottom 114 configured to form a container having an open upper end. The housing 101 is illustrated as having a vertically-elongated rectangular shape, but it is well within the scope of the invention to employ alternative shapes such as cylindrical or trapezoidal. The housing 101 is formed of a dielectric material. For example, the housing 101 may be formed of a chemically-inert plastic, such as, but not limited to, polypropylene.

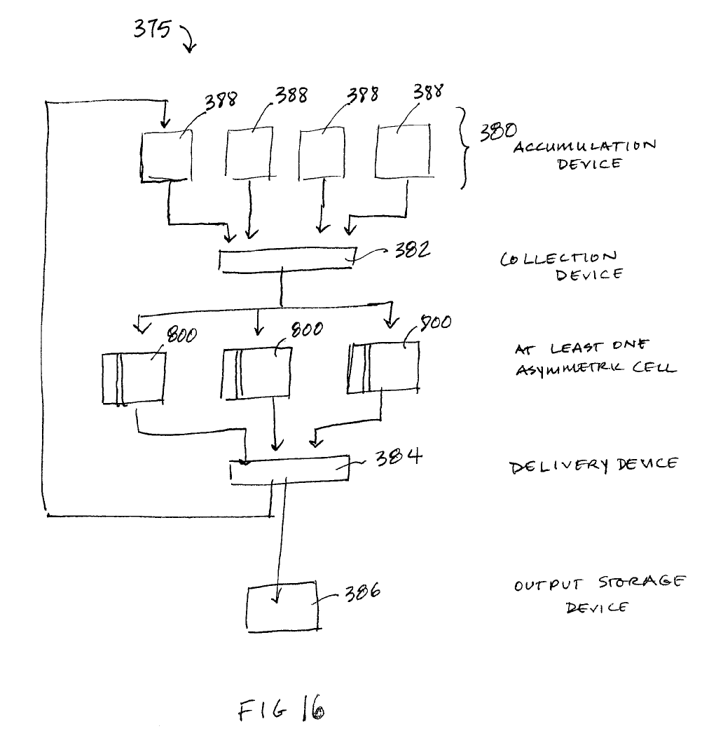

The housing 101 is segmented into two symmetric wells 116, 117 each having a separate well volume, using an electrically neutral membrane 109. Membrane 109 serves to electrically isolate liquids within the two wells 116, 117, effectively separating the electrical charge provided in the first well 116 from an electrical charge provided in the second well 117. Membrane 109 is a rigid, porous plate formed of a electrically neutral and chemically non-reactive fabric, the fabric being formed of materials such as, but not limited to, polypropylene or polyamide. In some embodiments, the membrane 109 is formed of a filtering fabric that includes polypropylene strings. The edges of the membrane 109 are fixed to the housing 101. In some embodiments, the edges of the membrane 109 are received in grooves 115 formed in the inner surface of the housing 101, whereby the position of the membrane 109 within the housing 101 is maintained (FIG. 1). In other embodiments, the edges of the membrane 109 are secured between parallel rails 125 provided on an interior surface of the housing 101 for that purpose (FIG. 17).

In the symmetric electroextraction cell 100, the membrane 109 is positioned within the housing 101 so as to provide a first well 116 which has substantially the same working volume as the second well 117. The membrane 109 may be provided having a thickness in a range from about 0.2 mm to about 1 mm (for example, from about 0.2 mm to about 0.4 mm, from about 0.3 mm to about 0.5 mm, from about 0.6 mm to 0.9 mm, and from 0.8 mm to 1.0 mm). In some aspects, the membrane 109 is formed having a maximum thickness of less than about 0.5 mm. The membrane 109 provides a region of reduced flow volume between the electrodes, creating an active zone having a small volume relative to the corresponding volume without a membrane 109. The effect of the region of reduced flow volume is to accelerate fluid flow from the first well 116 to the second well 117.

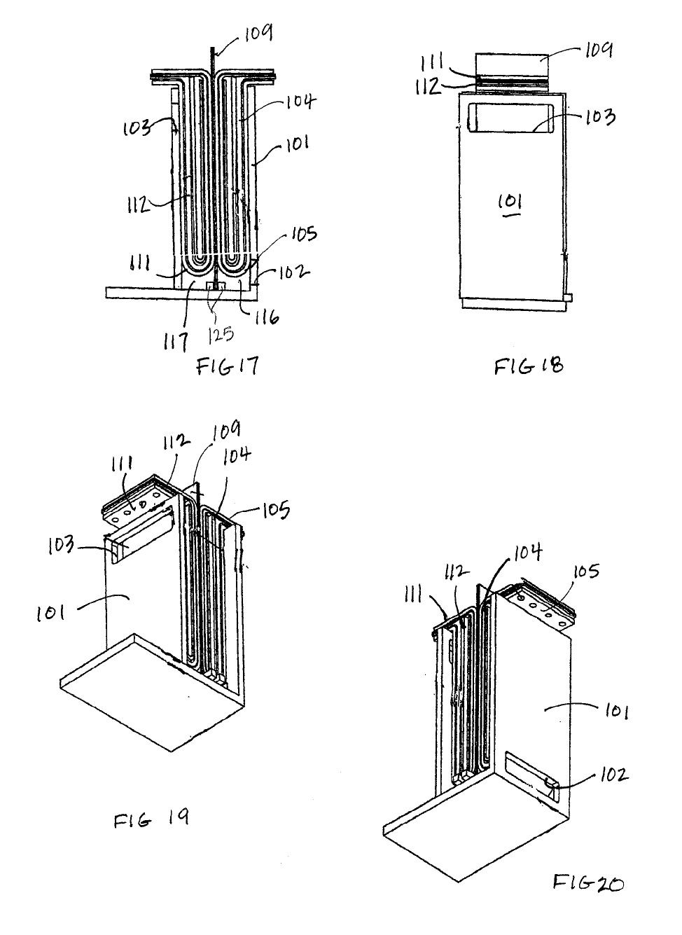

An inlet opening 102 is formed in the sidewall of the housing 101 adjacent to the bottom of the housing 101. The inlet opening 102 permits input of a liquid requiring treatment and processing into the internal cavity of the housing 101. Specifically, the inlet opening 102 permits fluid flow into the first well 116. In addition, an outlet opening 103 is formed in the sidewall adjacent to an upper edge of the housing 101. After treatment and processing of the liquid, the outlet opening 103 permits output of the liquid from the well 117. Specifically, the outlet opening 103 permits fluid flow to the exterior of the cell 100. As seen in FIGS. 18-20, the inlet opening 102 and outlet opening 103 are provided having a width that extends substantially across a width of the respective housing side so as to maximize fluid flow into and out of the housing 101.

A first electrode 104 is disposed within the first well 116, and a second electrode 112 is disposed within the second well 117. During processing of the contaminated liquid, the first electrode 104 is connected with a source of positive electric potential 201, and the second electrode 112 is connected with a source of negative electrical potential 204 provided, for example, by a battery 220 or other power source. The first and second electrodes 104, 112 are formed to be substantially structurally similar. For this reason, only the structure of the first electrode 104 will be described herein.

The first electrode 104 is made of a carbon carbon composite material, graphitic cotton wool, graphitic carbon wool, coal carbon wool or from coal cotton wool. For example, in some embodiments, the first electrode 104 is formed of coal carbon wool, which is an electrically conductive fabric that is chemically inert, flexible, can withstand very high temperatures, and can be formed into a desired shape. The coal carbon wool is pressed into plates 118, each plate having a thickness of approximately 5-8 mm. Each plate is folded back on itself one or more times, and one or more folded plates 118 are stacked to obtain a volume of material which is approximately the size of the first well 116. Thus, the first electrode 104 is sized and shaped to fit within, and substantially fill, an interior space of the first well 116 such that the active working volume of the electrode 104 generally corresponds to the volume of the first well 116. The volume of the first electrode 104 is determined by the requirements of the specific application, and is based on requirements for the productivity of the electroextraction cell 100. As an example, for a cell 100 in which a flow rate of up to three cubic meters per hour is required, a corresponding electrode 104 would have a volume measured in cubic centimeters. Of course, requirements of greater flow rates can be accommodated by electrodes having volumes measured in cubic meters.

At one end of the first electrode 104, the stacked plates 118 of coal carbon wool are bent and compacted into a substantially rectangular compressed region 108. The end of the first electrode 104 is bent in a direction away from the corresponding end of the second electrode 112, whereby inadvertent contact of the electrodes 104, 112 is avoided, and overall height of the electrochemical cell 100 is reduced. In some embodiments, compressed region 108 has an alternative shape, such as cylindrical. In some embodiments, the compressed region 108 may surrounded by a correspondingly-shaped metal plug 107, which in turn is connected to a source of positive electric potential 201. Compression of the electrode material in the compressed region 108 promotes efficient transfer of electrical charge from the plug 107 to the electrode material.

The above described electrode configuration provides a porous electrode of a predetermined working volume, the working volume defined by the dimensions of the volume of the carbon-carbon wool material disposed within the first well 116. It is understood that, due to the large surface area inherent to the carbon carbon wool fabric, and because the fabric permits liquid to pass through the entire working volume of the electrode, a very large active working surface area is provided within the working volume. In addition, the electrode configuration permits liquid to pass through the working volume in three orthogonal directions.

The first electrode 104 is bound by an elastic conductive band 105, and a substantially similar elastic conductive band 111 surrounds the second electrode 112. The conductive band 105 made of a carbon composite fabric created by a multi-step pyrolysis process in which a viscose fabric matrix is saturated with carbon (graphite). The resulting band structure is non-metallic, electrically conductive, porous, elastic, absorptive, and flexible. The band 105 is wrapped about the electrode in a stretched configuration so that it remains in place due to the elastic properties of the band 105 and so that good electrical contact is made between the band 105 and first electrode 104. The conductive band 105 surrounds at least a portion of the outer periphery of the first electrode 104. In some embodiments, the band 105 is in the form of a strip that extends about a circumference of the electrode (FIG. 21).

For example, the conductive band 105 may be formed in a U-shape, including a closed lower end 105c joining opposed first 105a and second 105b band sides. The electrode 104 may be press fit between the opposed band sides 105a, 105b such that a lower end of the electrode abuts against the inner surface 105d of the lower end 105c of the conductive band 105. The upper portion of the opposed first and second sides may be bent to correspond to the bent shape of the electrode 104, and may also include connectors 105f for connecting to an external source of electric power. In other aspects, the conductive band 105 may be provided in other shapes such that the outer peripheral surfaces of the first electrode 104 may be essentially enclosed by the conductive band 105. In addition, the conductive band 105 is directly connected to a source of positive electric potential. The ends of the conductive band 105 are provided with vertically aligned holes 105f, and an electrical conductor from a power source passes through the upper hole 105f, through the electrode 104, and through the corresponding lower hole 105f.

The first electrode 104 is disposed within the first well 116 so as to be interposed between the membrane 109 and the sidewall 113. In some embodiments, a rigid plate 106 may optionally be used to maintain a desired geometric shape of the first electrode 104. As seen in FIG. 1, a rigid plate 106 is disposed between the sidewall and conductive band-covered side of the first electrode 104.

The first electrode 104 serves as an anode due to its connection with a source of positive electric potential through metal plug 107 which acts in the compressed region 108, and through the conductive band 105, which acts along the entire outer periphery of the first electrode 104. This configuration provides an electrode in which the charge density over the electrode 104 is highly controllable and substantially uniform throughout its volume.

In a similar manner, the second electrode 112 is disposed within the second well 117. The second electrode 112 is formed to have a volume of material which is approximately the size of the second well 117. The second electrode 112 is bound by a conductive band 111 which is substantially identical to conductive band 105, and is connected with a source of negative electric potential through a metal plug 110, and through the conductive band 111, which acts along the entire outer periphery of the second electrode 112. As a result, the second electrode 112 serves as a cathode.

In summary, the cell 100 for electrolytic extraction of metals from metallic liquids includes a housing 101 segmented into at least two generally symmetric wells 116, 117 separated by an electrically neutral, porous membrane 109, an electrode 104, 112 disposed within each well, at least one source 120 of constant electric potential connected to the electrodes, and a covering 105 on the external surface of the electrodes, the covering 105, 111 providing a porous, elastic, nonmetallic woven contact for connection to a source of constant electric potential. The electrolytic cell 100 further includes an input 102 for inputting of a metal-contaminated liquid into the volume of the first electrode 104, which is connected to a source of positive electric potential, and an output 103 for outputting the processed liquid from the volume of the second electrode 112, which is connected to a source of negative electric potential.

The following tables provides examples of technical parameters of the illustrated embodiment of the electrolytic cell 100:

| | |
|---|---|
| DC current load per one electrochemical | 150 A |
| reactor | |
| Voltage | 6 to 12 V |
| Number of anode chambers | 1 |
| Number of cathode chambers | 1 |
| Maximum amount of metal precipitated at | 8 kg |
| the electrochemical reactor's cathode | |
| Percentage of metal extraction | 99.5% |
| Production capacity | 0.3 cubic meters per hour |

Due to the high rate of the liquid exchange at the volume-porous electrodes' active surface which corresponds to the extensive surfaces provided within the volume of the electrodes, it is possible to raise the effective current density by a factor of 10 relative to that of conventional electrochemical reactors with planar electrodes, resulting in a 100-fold increase in the production capacity of the cell, and in the metal extraction speed.

Of a special importance is the design of electrodes 104, 112, particularly the pioneering design of elastic conductive bands 105, 111 manufactured of a composite viscose based fabric pyrolytically saturated with carbon. The conductive bands 105, 111 are is completely chemically inert, and assure electrical connection over substantially the whole electrode surface, which reduces the current loss, and avoids the destruction which occurs when conventional metallic contacts are used within an electrochemical reactor.

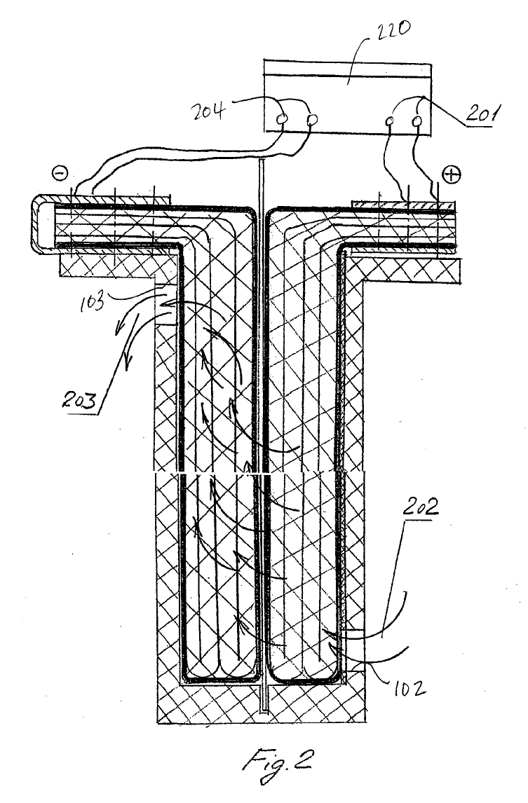

Referring now to FIGS. 2 and 3, operation of an individual cell 100 will now be described in detail. In operation, the liquid to be treated and processed is forced to enter inlet opening 102. The liquid may be driven using conventional techniques, which may include using the influence of forces of gravitation, and/or pumping. In the preferred embodiment, the housing 101 is disposed within an external tank 301 filled with the liquid to be treated, whereby the head of liquid above the inlet opening 102 generates the required driving force.

The stream 202 of the liquid to be processed, enters the first well 116 in a laminar mode and moves inside the working volume of the first electrode 104 by passing through porous contact 105. At this time, the working volume of the first electrode 104 is under the influence of positive electric potential, owing to the connection of contact 105 and metal plug 107 to the source of positive electric potential 201, provided by a power supply 220. Under gravitational force, the liquid rises upwards in the working volume of electrode 104, and under influence of the same forces, filters through the membrane 109 into the second well 117. Within the second well 117, the liquid passes through conductive band 111 into the internal working volume of the second electrode 112, which is connected to a source of negative electric potential 204, provided by the power supply 220. Metal ions, being positively charged due to passage through the working volume of the positively charged first electrode 104, are attracted to the surfaces of the negatively charged second electrode 112, and thus are extracted from the liquid. After being processed through the working volume of the second electrode 112, the treated, substantially metal-free liquid leaves in stream 203 through the output opening 103. The treated liquid is collected in a tank 303 provided for that purpose.

In this embodiment, since the working volume of the respective electrodes 104, 112 is substantially the same as the volume of the corresponding well 116, 117, the distance between electrodes is determined only by the thickness of the membrane 109. As a result, this distance is only a maximum of about 0.8 to 1.0 mm, and may be as little as 0.2 mm, whereby the efficiency of the galvanic pair is very high.

Moreover, the entire volume has an active galvanic function. Specifically, from the moment of input of a liquid into the working volume of the second electrode 112, which is connected to a source of negative electric potential, a high-speed process of electro-sedimentation of the metals begins.

The volumetric structure of the electrodes 104, 112, which are made from carbon fibers, results in a significantly large active working surface area within the respective electrodes 104, 112. This large active working surface area is provided with a source of uniform, constant electric potential. In some aspects, at least about 50% of the active working volume of the one or more electrodes of the electrode cell is provided with this uniform, constant source of electric potential, and as much as about 99% or more of the active working volume of the one or more electrodes of the electrode cell may be provided with the uniform, constant source of electric potential. This is turn results in a significant gain of the electro-sedimentation of metals is achieved on the surface of the carbon fibers from an increased current density in the electrode relative to conventional electrodes.

The electroextraction cell 100 can also include a sensor 150 located on an external surface of the housing 101 in the vicinity of the cathode 112. The thickness of a cathode metal sedimentation is determined by a means of the sensor 150, which may be a magnetic resonance sensor. In use, the cathode metal can be configured such that for a specific definition of the thickness of the cathode metal the electrical resistance of the cathode is changed, and the change in resistance is determined by the sensor 150.

As described above, metal ions are attracted to the surfaces of the negatively charged second electrode (cathode) 112, and thus are extracted from the liquid. The metal is deposited within the cathode's 112 volume. After the internal volume of the cathode 112 is filled with metal, the cathode may be removed from the cell 100 and a new cathode 112 may be installed and the process can be repeated. Metal can be subsequently be removed from the electrode 112 as an ingot using pyrometallurgic, electrochemical or chemical methods processes.

### Module Including Plural Symmetric Electrode Cells

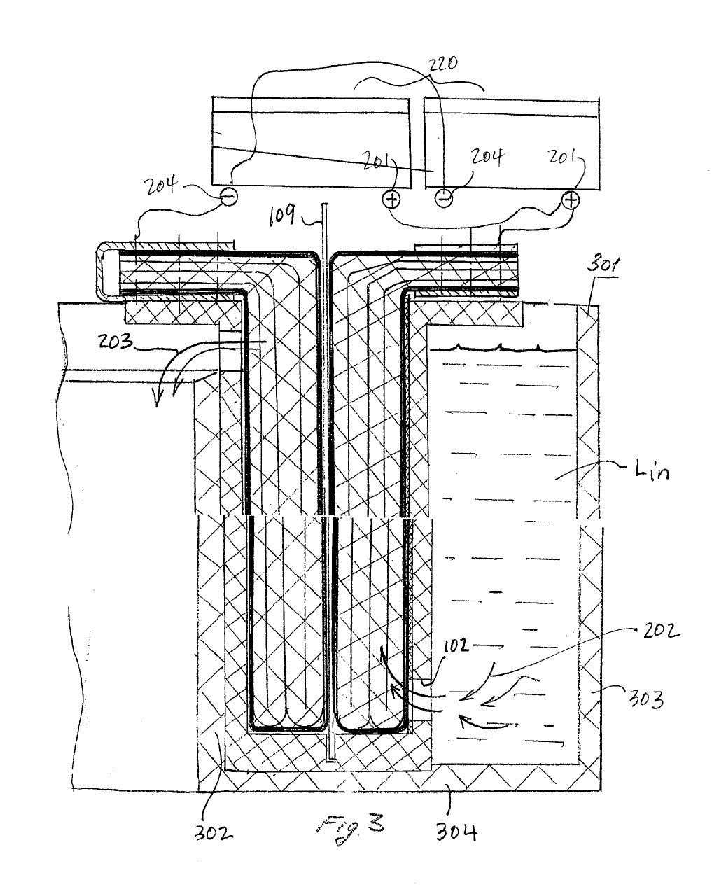

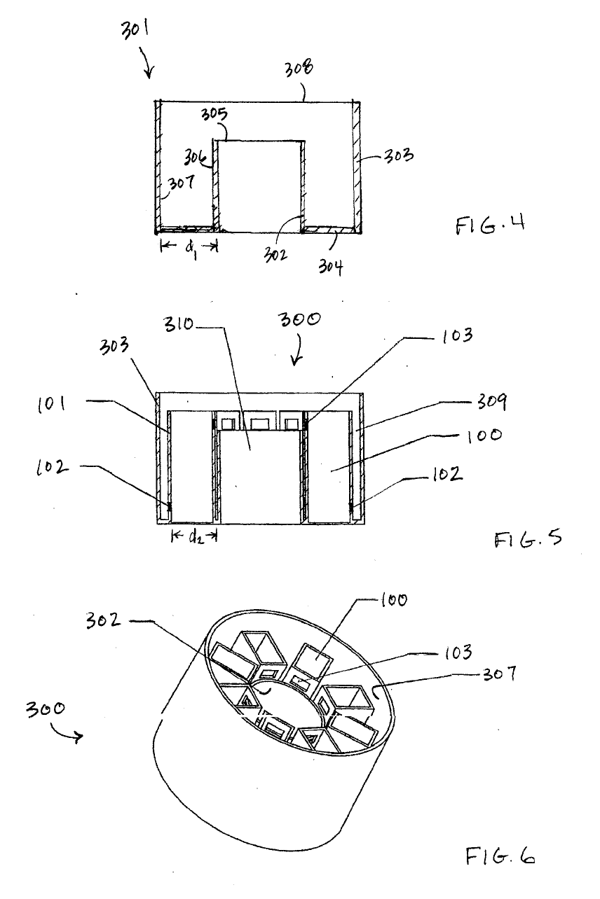

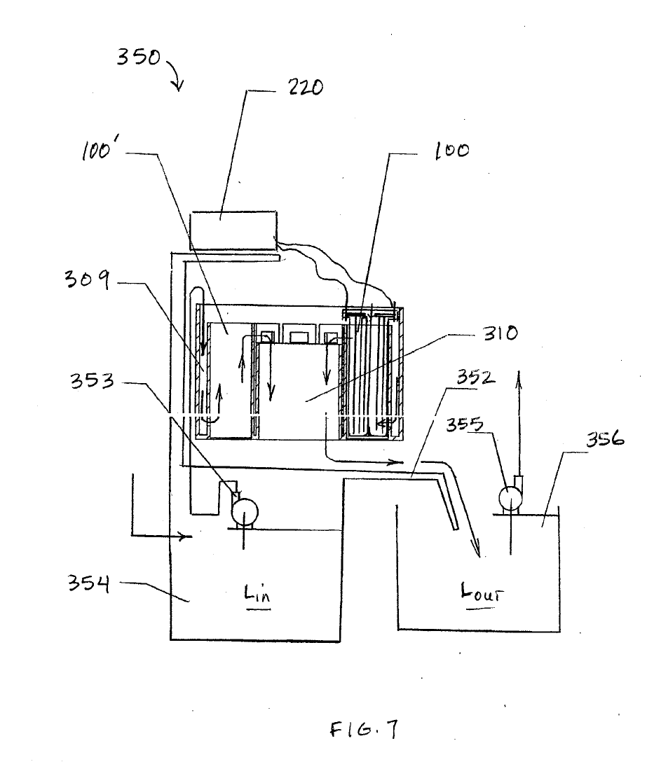

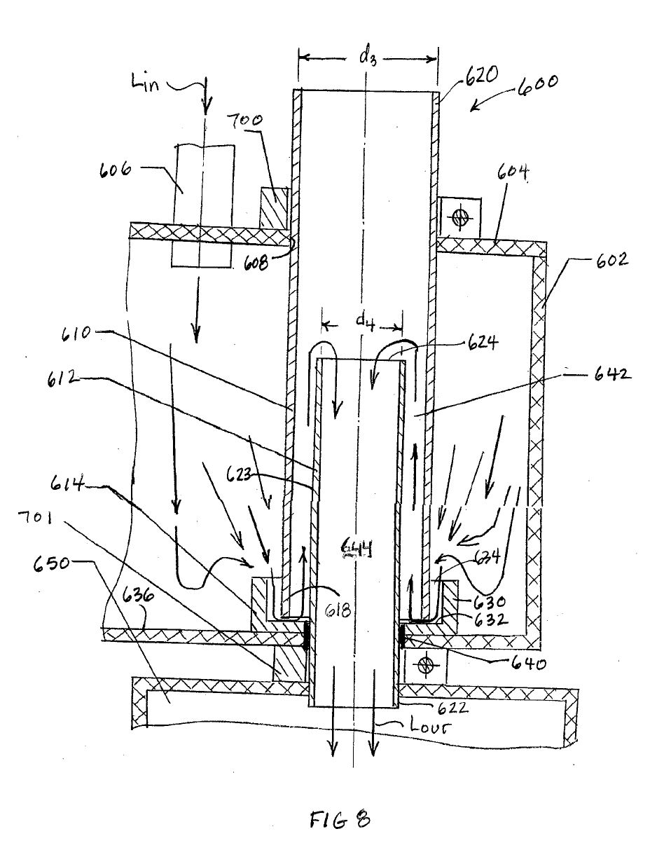

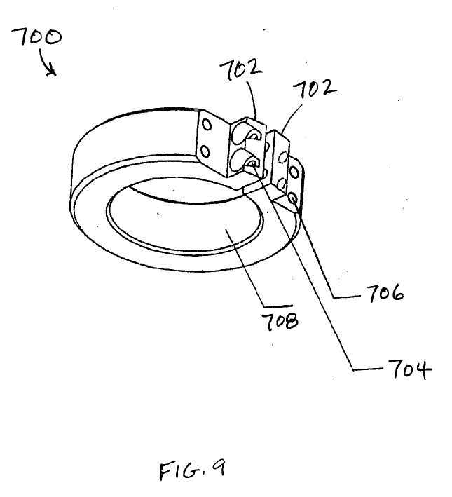

A plurality of electroextraction cells 100 can be arranged together within the external tank 301 to form a module 300 in order to achieve improved process throughput. Referring now to FIG. 4, the external tank 301 is illustrated as formed of a pair of concentric hollow cylinders joined at their respective lower ends to form an annular trough.

A bottom surface 304 closes the lower side of the external tank 301, and extends between a lower end of the external wall 303 and a lower end of the internal wall 302. The height of the external wall 303 is greater than height of the electroextraction cells 100, and the height of the internal wall 302 is less than the height of the electroextraction cells 100. In particular, an upper edge 305 of the internal wall 302 terminates at a height that is below that of the outlet opening 103. As seen in FIG. 5, in which the power supply 120, the electrodes 104, 112, and membrane 109 for each cell 100 are omitted for purposes of clarity, when electroextraction cells 100 are disposed within the external tank 301, the radial distance d₁ between the internal wall 302 and the external wall 303 is greater than the corresponding dimension d₂ of the electroextraction cell 100 in the radial direction. In addition, the electrode cells are arranged to abut a radially outer surface 306 of the internal wall 302, so that a cavity 309 is provided between a radially inner surface 307 of the external wall 303 and the confronting surface of the electroextraction cells 100.

The plurality of electroextraction cells 100 are arranged in a circular formation within the interior space of the external housing 301. In this example, eight electroextraction cells 100 are shown. However it is well understood that a module 300 can be formed having fewer or greater numbers of electrode cells. For example, the module 300 may include 2, 3, 4, 5, 6, 7, 8, 9, 10, 11, 12 or more cells 100. Moreover, although the external tank 301 is illustrated as having a circular cylindrical shape, it is well within the scope of this invention to provide a tank shape which is non-circular, as long as the shape is a closed-wall shape.

The cavity 309 between the electroextraction cell 100 and the internal surfaces of the external tank is filled with liquid Lᵢₙ to be processed, that is, liquid containing metals in solution. The level of the liquid Lᵢₙ in the external tank 301, is sufficient to create internal pressure forces acting under the influence of gravity (head) that press the liquid Lᵢₙ into the electrode, and through the volume of electrodes. The level is regulated to an upper limit which is less than the height of the housing 101 of the electroextraction cell 100.

Under the influence of gravity, the liquid Lᵢₙ is forced to enter inlet opening 102 of the electroextraction cell 100, passes through the volume of the first electrode 104, the membrane 109, and the volume of the second electrode 112, to effect the removal of metal ions from the liquid. A processed liquid Lₒᵤₜ, that is, liquid that has had up to 99 percent of the metal contaminants removed, exits outlet opening 103 of the electrode cell. The housing 101 of the electrode cell is arranged to abut the internal wall 302 of the external tank 301 such that the outlet opening 103 faces radially inward. As a result, the liquid Lₒᵤₜ exiting from the outlet opening 103 is directed into the open internal space 310 within the internal wall 302, where it falls under force of gravity to a drain 352.

In the possible variants of configurations of the electrochemical processing modules 300, the hydraulic parameters of all electroextraction cells 100 are substantially identical regardless of the number of electroextraction cells 100 provided, since the pressing of the water solution through volume of the electrodes 104, 112 is accomplished by gravity flow in the vessels. This equality of hydraulic parameters across all electroextraction cells 100 eliminates electric power losses and insures consistent electro-sedimentation rates at each of the electrochemical reactors in the system.

### Module System

As seen in FIG. 7, the module 300 can be used in an electroextraction system 350 in which the module 300 is provided with a plurality of electroextraction cells 100 that are each connected to a power source 200. In this figure, the left-side electroextraction cell 100′ is shown without the electrodes 104, 112, membrane 109, or electrical connections in order to more clearly illustrate the flow path of the liquid through the system. In the system 350, the module 300 is arranged to receive liquid to be processed Lᵢₙ from an input storage tank 354 by means of a pump 353. The clean processed liquid Lₒᵤₜ exiting from the module 300 falls under force of gravity through the drain 352 to an output storage tank 356. The system 350 further includes an output pump 355 configured to direct the liquid Lₒᵤₜ to a downstream application and/or release it to the environment.

Although a single module 300 is used in the system 350 in the illustration of FIG. 7, it is understood that the system 350 can be configured to accommodate a plurality of modules receiving power from one or more power supplies 220, receiving input liquid Lᵢₙ from one or more input storage tanks 354, and directing output liquid Lₒᵤₜ to one or more output storage tanks 356.

A method of extracting metals from liquid solutions using electroextraction techniques will now be described. The method uses at least one electrode cell and includes the following method steps:
Provide a symmetric electroextraction cell 100 as described above.
Complete an electrical contact of the electrodes 104, 112 of an electroextraction cell 100 to a source of constant electric potential 220. In this step, the electrodes include the active working volume and all active working surfaces of the electrodes.
Apply a constant electric potential on an electroextraction cell 100 by connecting one electrode 104 of the electrode pair to a source of positive potential 201, and connecting the other electrode 112 of the electrode pair to a source of negative potential 204.
Create the directed stream of a liquid to be processed Lᵢₙ in the inlet opening 102 of an electroextraction cell 100. As discussed above, the liquid Lᵢₙ may be driven using conventional techniques, which may include using the influence of forces of gravitation, and/or pumping.
Form an ascending stream of a metallic liquid through the volume of positively charged electrode 104. This is achieved by locating the outlet opening 103 of the electrode cell at a position above the inlet opening 102. In order to maximize the ascending effect in which use of the available volume of the electrode and distance traveled by the liquid through the volume are maximized, the inlet opening 102 is positioned adjacent a lower edge of the cell housing 101, and the outlet opening 103 is positioned adjacent to an upper edge of the cell housing 101.
Electrically press liquids from the ascending stream in the positively charged electrode 104, through the porous and electrically neutral membrane 109, to an active working volume of the negatively charged electrode 112. Herein, the term “electrically pressing” refers to application of electrical charge to direct the flow of ions.
Form an ascending stream of a metallic liquid through volume of the negatively charged electrode 112.
Create a high speed process of electro-sedimentation in the the active working volume of the negatively charged electrode 112.
Output a stream of a treated liquid from the active working volume of the negatively charged electrode 112.

The method of extracting metals from liquid solutions using the above electroextraction system can also include providing remote control of the electrochemical processes, wherein the remote control comprises using magnetic resonance sensors to measure a level of electric resistance of the liquid before electrochemical processing.

### Electro-Coagulation

In some embodiments, electro-coagulation is used to remove metals from a liquid solution using an electro-coagulation cell 600 (FIG. 8). The electro-coagulation cell 600 includes a consumable hollow cylindrical anode 610 installed coaxially with a non-consumable hollow cylindrical cathode 612. The coaxial electrode cell 600 can be operated with or without a cell housing. The hydraulic principle of action for an electrochemical electrode cell without a housing to produce electro-coagulation in a stream of a liquid is similar to a principle of submission of a liquid to be processed in the module for electrochemical processing.

The anode 610, being consumable, is made from materials having good coagulation and flocculation effect, which include, but are not limited to aluminum, aluminum alloys, iron and low carbon steel.

The cathode 612 is formed to be non-consumable. In order to accomplish this, the cathode 612 may be made from chemically inert metals or alloys thereof having an outer protective current carrying covering. For example, the cathode may be formed of a base of stainless steel with the contents of the alloying impurities being not less than 25 percent, titanium or titanium alloys, and may be covered with materials, such as platinum, palladium, oxides of ruthenium, or coverings from current-carrying polymers, that that are effective in increasing the working capacity of the cathode. Alternatively, the cathode 612 may be covered with a composite non-metallic material having a similar structure to the elastic conductive band 105 and thus is provided with a special covering to provide a working surface that increases the working capacity of the electrode.

As seen in FIG. 8, the electro-coagulation device 600 is mounted within a container 602 for receiving a liquid Lᵢₙ to be processed in which metals are held in solution. The container 601 includes a cover 604 whereby the container 601 is closed, and is illustrated as having a generally rectangular shape. However, the container 601 is not limited to the illustrated shape and may be formed in other closed shapes. An inlet opening 606 is formed in the cover to permit flow of the liquid Lᵢₙ into the interior space of the container 601.

In addition, a second opening 608 is formed in the cover 604 that is sized and shaped to receive the cylindrical anode 610. The anode 610 extends vertically downward from the cover 604, and a lower end 618 of the anode 610 is received within a cup-shaped member (activator) 614 disposed on an inner surface of the container bottom 636. The height of the anode 610 is greater than that of the height of the container 601, so that the upper end 620 of the anode extends upward above the cover. A first contact clamp 700 is connected to the anode 610 at a location above the cover 604, and is used to electrically connect the anode to a source of positive potential, and to support the anode in a desired position with respect to the container 602 and cathode 612.

The structure of the contact clamp 700 is illustrated in FIG. 9. The contact clamp is electrically conductive and formed into C shape that nearly completely encircles the exterior surface of the cylindrical body to be clamped, which in this case, is the anode 610. The opposed ends 702, 702 of the contact clamp 700 are confronting and spaced apart, and are connected together using closing screws (not shown) which extend through screw holes 704 formed within the opposed ends. Adjustments in the circumference of the contact clamp 700 are made by adjusting the closing screws within the screw holes 704. In use, a contact clamp 700 is selected to have an inner diameter that is substantially the same as the outer diameter of the cylindrical body to be clamped, so that when the contact clamp 700 encircles the cylindrical body, adjustment of the closing screws changes the spacing between the opposed ends 702, 702, reducing the circumference of the contact clamp 700 and permitting the contact clamp 700 to be tightly connected to that body, whereby electrical conductance between an inner surface 708 of the contact clamp 700 and an outer surface of the body is achieved. Apertures 706 for fastening a conductive cable from a power supply are also formed in the opposed ends 702, 702. A plurality of apertures 706 are provided to accommodate one or more conductive cables as needed to meet the current density requirements of the specific application.

The container bottom 636 is provided with a bottom opening 638 that is sized and shaped to receive the cylindrical cathode 612. The center of the bottom opening 638 is in vertical alignment with the center of the second opening 608 formed in the cover 604. Thus, the cathode 612, extending vertically within the bottom opening 638, is arranged concentrically with the anode 610. The cathode 612 is positioned relative to the container 602 such that an upper end 624 and mid portion 623 of the cathode reside within the hollow interior space of the anode 610, and a lower end 622 of the cathode is disposed below the container bottom 636. A gasket 640 is provided between an outer surface of the cathode 612 and the bottom opening to prevent fluid leakage between these members. A second contact clamp 701 is connected to the lower end 622 of the cathode 612 at a location below container bottom 636, and is used to electrically connect the cathode to a source of negative potential, and to support the cathode in a desired position with respect to the container 602 and anode 610.

In the electro-coagulation device 600, the anode 610 is provided with an inner diameter d3 which is greater than the outer diameter d4 of the cathode 612. Thus, when the cathode 612 resides within the anode 610, an inter-electrode space 642 is formed between the respective electrodes 610, 612. In addition, using the contact clamp 700, the vertical position of the anode 610 is adjusted so that the anode lower end 618 is adjacent to, but spaced apart from, the cup bottom 632. The spacing between the anode lower end 618 and the cup bottom 632 is determined based on the requirements of the specific application, including flow rate requirements.

When the contact clamps 700, 701 are installed on electrodes 610, 612, the structure of the contact clamp 700, 701 permits both rotation of the clamp relative to the electrode body before being secured, as well as linear movement of the clamp along the cylindrical surface of the electrode body, whereby the contact clamps 700, 701 can be installed in any location on an electrode 610, 612. This design permits adjustability within an electrode cell as these contact positions are varied. For example, the length of inter-electrode space 642 can be adjusted. In addition, each electrode 610, 612 can be displaced in an axial direction differently than the other. It should be noted that the ability of the anode 610 to be moved axially permits compensation for a reduction in length of an inter-electrode space 642 due to consumption of the anode 610, whereby recycling of the anode 610 is achieved, and maintenance of the conditions in the inter-electrode space 642 is enabled. Maintenance of the constant characteristics and working parameters of the electrodes 610, 612 considerably improves the efficiency of process of electro-coagulation.

As seen in FIG. 8, sidewalls 630 of the cup member 614 surround the anode lower end 618, restricting the flow of liquid into the cup member 614 and inter-electrode space 642. The cup member 614 is made of the same material as the cathode 612, and is also connected to the source of negative electric potential 204. As a result, the cup member 614 creates an activating channel around the bottom end face of the anode 610 through which the liquid being processed passes into the inter-electrode space 642. This passage establishes a regional effect where maximal erosion of the anode 610 occurs and the anode ions are maximally (speed) carried away in the liquid. Thus, the cup member 614 acts in the region of the anode lower end 618 to stimulate the effect of the dissolution of ions from the anode 610. The regional effect is due to the combination of the position of the anode 610 within the cup member 614, and the shape of the cup member 614 which directs flow in the vicinity of the anode 610.

During operation of the electro-coagulation device 600, it is necessary in regular intervals to quickly dissolve the metal of the anode 610 and to direct it to the stream of liquid to be processed. Thus it is necessary to use the regional effect of the anode placement relative to the cup member 614 to intensify the erosion process of the end face of the anode 610. In the electro-coagulation device 600, the electrodes 610, 612 are installed coaxially, so that a large surface area of the anode 610 faces a confronting surface area of the cathode 612, and has a much greater active working surface. As a result, the operation of the coaxial electrochemical electrode device for electro-coagulation can be carried out as an asymmetric electrode cell. The asymmetric electrochemical electrode cell differs from a symmetric electrochemical electrode cell in that the volume of one electrode in an electrode pair is a different size. The greater the volume of an electrode, the greater the level of polarization of the electrode and the greater the level of influence of the electrode on the character of the electrochemical changes in the liquid which passes through its volume.

In this embodiment, the anode 610 has a much greater working surface than the cathode 612, and the external surface of the anode functions to provide preliminary activation of the liquid. The internal surface of the anode 610 and external surface of the cathode 612 cooperate to provide the inter-electrode space 642, and the cathode 612 provides a galvanic function of bringing ions from anode to cathode.

The liquid to be processed Lᵢₙ enters into a cavity between the cup member (activator) 614 and the lower end face 618 of the anode 610. Due to the regional effect, the lower end face 618 of the anode 610 dissolves and the liquid passing the activating channel is coagulated with a ionic material. The liquid Lᵢₙ, including dissolved anode matter, enters into the inter-electrode space 642 between the cathode 612 and the anode 610 in which dissolution of the anode proceeds and in which additional ionic material is coagulated. Under the force of gravity, the liquid Lᵢₙ flows from the lower end 618 of the anode 610 to the upper end 624 of the cathode 612. The liquid Lᵢₙ then pours through the open top end face of the cathode 612, and since the electrode 612 is cathodic, the energy potential promotes an increase in speed of formation of irreversible hydroxides and increases the efficiency of coagulation. Finally, the liquid exits from the internal cavity 644 of the cathode 612 under the force of gravity. The liquid Lₒᵤₜ exiting from the cathode 612 is collected in a sedimentation tank 650. When the coagulated material reaches a certain level of concentration, the process of flocculation begins, gradually forming hydroxides of the metals in the liquid, and thus sedimentation of precipitation occurs permitting the cleared liquid to be collected.

The electro-coagulation device 600 described herein is less expensive to operate than conventional electro-coagulation devices. In an electro-coagulation system, it is desirable to recirculate water many times through a process. In a conventional system using conventional electrodes, destruction of both the anode and cathode occurs after a short period of time. Moreover, the conventional cathode experiences passivation, and the destruction residuals from the electrodes remain in the water and interfere with the metal removal process. However, in the electro-coagulation device 600, the cathode is formed of coal carbon wool. Since the cathode is non-reactive and inert, no destruction of the cathode occurs. As a result, the cathode does not require period replacement, no destruction residuals are released into the water stream, and passivation of the cathode does not occur.

It should be noted that the constructive attributes specified above provide an electrode cell that does not have a housing, and is instead installed directly in a collection tank. In addition, creating the current density within the electrodes capable of producing of electro-coagulation of metal results in creation of a current density capable of producing a high-speed process of electro-coagulation of metal.

A method of extracting metals from liquid solutions using electro-coagulation techniques will now be described. The method uses at least one coaxial electrode cell in which both internal and external cylindrical surfaces of the electrodes are used. The electro-coagulation method includes the following method steps:
Provide an asymmetric electrolytic cell 600 as described above.
Complete an electrical contact of the electrodes 610, 612 of an electrode device 600 to a source of constant electric potential 220.
Apply a constant electric potential on an electrode device 600 by connecting one electrode 610 of the electrode pair to a source of positive potential 201, and connecting the other electrode 612 of the electrode pair to a source of negative potential 204.
Create the directed stream of a liquid to be processed Lᵢₙ between the cup member 614 and the lower end 618 of the anode 610. As discussed above, the liquid Lᵢₙ may be driven using conventional techniques, which may include using the influence of forces of gravitation, and/or pumping.
Form an ascending stream of a metallic liquid through the inter-electrode space 642. Here, the inter-electrode space is used to increase the flow rate, whereby plating velocity is increased.
Form a descending stream of a metallic liquid through internal cavity 644 of the negatively charged electrode 612.
Output a stream of a clean liquid from the negatively charged electrode 612.

The method of extracting metals from liquid solutions using electrocoagulation techniques can also include providing remote control of the electrochemical processes, wherein the remote control comprises using magnetic resonance sensors to measure a level of electric resistance of the liquid before electrochemical processing. The method can also include using magnetic resonance sensors to monitor a level of electrical conductivity in the liquid before and after processing, and then regulating the electrical parameters of the electro-sedimentation processes based on an active surface and the volume of the cathode and the metals contained in the liquid as measured in the monitored level of electrical conductivity.

### Electrochemical Alteration of Liquid pH

It is understood that the greater the volume of an electrode, the greater the level of polarization of the liquid generated by this electrode and the greater the level of influence of this electrode on the character of the electrochemical changes in the liquid which passes through its volume. Thus, in some embodiments, the electrode cell is formed asymmetrically to influence the character of the electrochemical changes within the cell, and particularly to adjust the pH level of the liquid in the cell. The practical application of such an electrode includes, but is not limited to, electrolytic disinfection of the liquid being processed, and for regulation of the of the acidity and alkalinity of the liquid being processed.

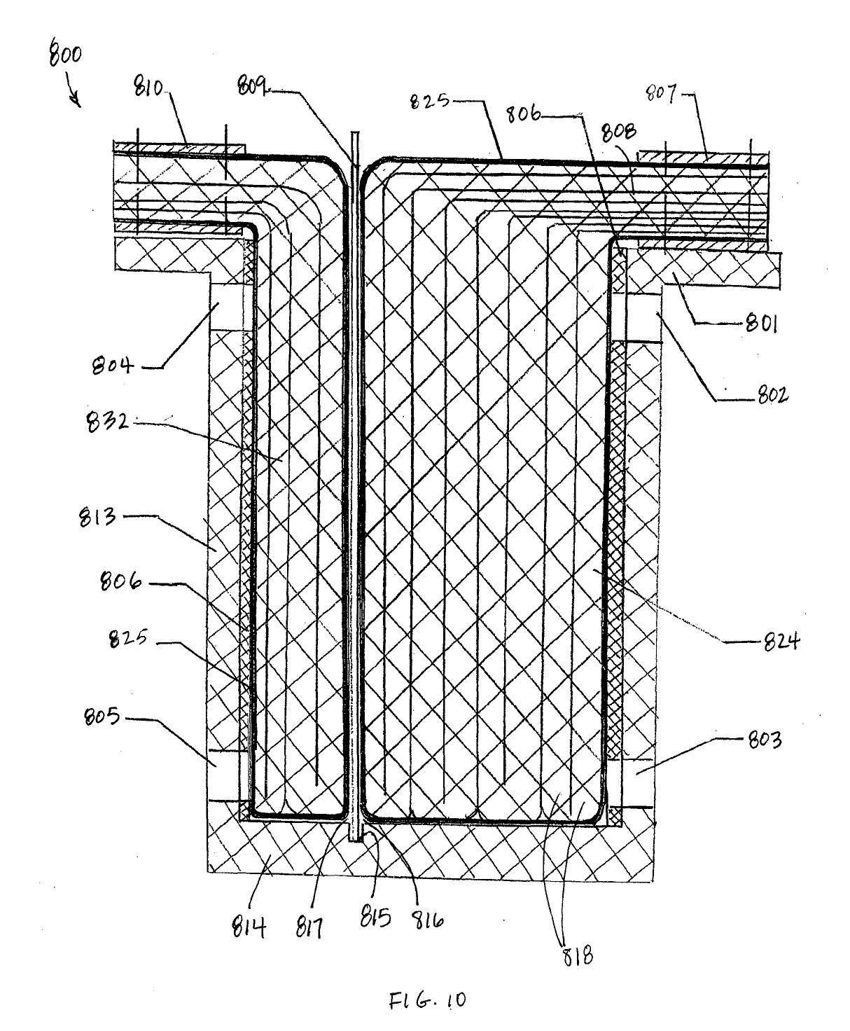

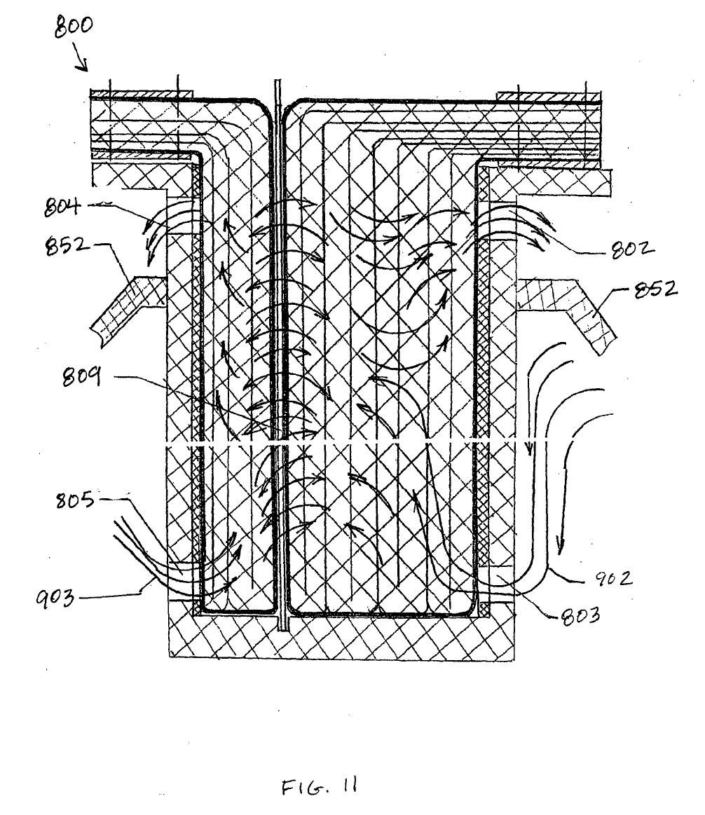

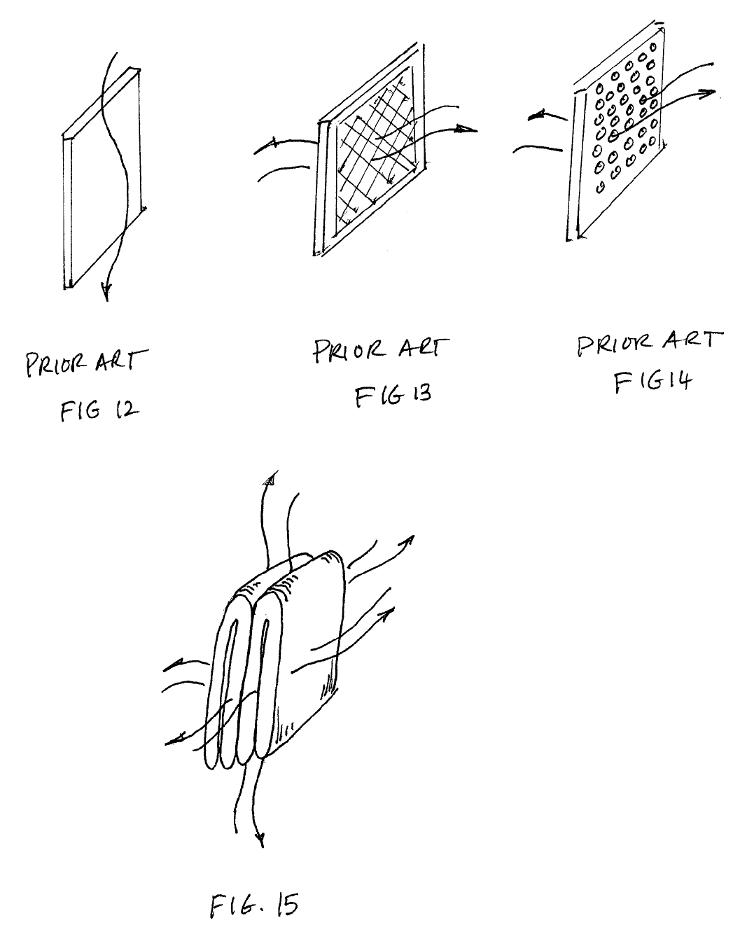

The asymmetric electrochemical electrode cell differs from a symmetric electrochemical electrode cell in that the volume of one electrode in an electrode pair is a different size. As seen in FIG. 10, one electrode of the electrode pair (for example, electrode 824) has a volume that is greater than the other electrode of the electrode pair (for example, electrode 832). In addition, an asymmetric electrochemical electrode cell differs from a symmetric electrochemical electrode cell in that each electrode well has an input channel (for example, 803, 805) and each has an output channel (for example, 802, 804).

In this approach, electrolytic disinfection of the liquid being processed, and/or regulation of the of the acidity and alkalinity of the liquid being processed is accomplished using an asymmetric electrolytic cell 800 which includes volume-porous electrodes and electrical contacts in the form of an elastic band from a fabric made of a carbon composite.

The asymmetric electrolytic cell 800 includes a housing 801, which includes closed sidewalls 813 and a bottom 814 configured to form a container having an open upper end. The housing 801 is illustrated as having a vertically-elongated rectangular shape, but it is well within the scope of the invention to employ alternative shapes such as cylindrical or trapezoidal. The housing 801 is formed of a dielectric material. For example, the housing 801 may be formed of a chemically-inert plastic, such as, but not limited to, polypropylene.

The housing 801 is segmented into two wells 816, 817 each having a separate working volume, by means of an electrically neutral membrane 809. The structure and function of membrane 809 is substantially similar to that of the membrane 109 described above with respect to the symmetric electrode cell 100.

Membrane 809 is a rigid, porous polypropylene fabric plate having edges which are received in grooves 815 formed in the inner surface of the housing 801, whereby the position of the membrane 809 within the housing 801 is maintained. In this embodiment, the membrane 809 is positioned within the housing 801 so as to provide a first well 816 which has a substantially greater working volume than the second well 817. For example, in some embodiments the first well 816 may be approximately twice the size of the second well, but the relative sizes of the wells may vary, and will be determined by the requirements of the specific application.

A first inlet opening 803 is formed in the sidewall 813 of the housing 801 adjacent to the bottom 814 of the housing 801. The first inlet opening 803 permits input of a liquid requiring treatment and processing into the first well 816 formed within the housing 801. In addition, a first outlet opening 802 is formed in the sidewall 813 adjacent to an upper edge of the housing 801 which permits fluid flow to the exterior of the housing 801 from the first well 816. After treatment and processing of the liquid, the first outlet opening 802 permits output of an analyte, a liquid having acidic reaction, from the first well 816.

In addition, a second inlet opening 805 is formed in the sidewall 813 of the housing 801 adjacent to the bottom 814 of the housing 801. The second inlet opening 805 permits input of a liquid requiring treatment and processing into the second well 817 formed within the housing 801. In addition, a second outlet opening 804 is formed in the sidewall 813 adjacent to an upper edge of the housing 801 which permits fluid flow to the exterior of the housing 801 from the second well 817. After treatment and processing of the liquid, the second outlet opening 804 permits output of a catalyte, a liquid having alkaline reaction, from the second well 817.

A first electrode 824 is disposed within the first well 816, and a second electrode 832 is disposed within the second well 817. The structure and function of electrodes 824, 832 are substantially similar to that of electrodes 104, 112 described above with respect to the symmetric electrode cell 100, except that size of the first electrode 824 is different than that of the second electrode 832.

The first electrode 824 is formed to have a volume of material which is approximately the size of the first well 816. At one end of the first electrode 824, the plates 818 of coal cotton wool are bent and compacted into a compressed region 808. The compressed region 808 is surrounded by a metal plug 807, which in turn is connected to a source of positive electric potential 201. This configuration provides a porous electrode of a predetermined working volume, the working volume defined by the dimensions of the volume of the carbon-carbon wool material disposed within the first well 816. It is understood that, due to the large surface area inherent to the carbon carbon wool fabric, and because the fabric permits liquid to pass through the entire working volume of the electrode 824, a very large active working surface area is provided within the working volume.

The first electrode 824 is bound by an elastic conductive band 825. The conductive band 825 is substantially similar to the conductive band 105 of the symmetric electrode cell 100. The conductive band 825 encloses at least a portion of the outer periphery of the first electrode 824. In some aspects, the conductive band 825 substantially extends about a circumference of the first electrode 824. In other aspects, the outer peripheral surfaces of the first electrode 824 may be essentially enclosed by the conductive band 825. In addition, the conductive band 825 is connected to a source of positive electric potential.

The first electrode 824 is disposed within the first well 816 so as to be interposed between the membrane 809 and the sidewall 813. A rigid plate 806 may optionally be used to maintain a desired geometric shape of the first electrode 824. As seen in FIG. 10, the rigid plate 806 is disposed between the sidewall and conductive band-covered side of the first electrode 824.

The first electrode 824 serves as an anode due to its connection with a source of positive electric potential through metal plug 807 which acts in the compressed region 808, and through the conductive band 825, which acts along the entire outer periphery of the first electrode 824. This configuration provides an electrode in which the charge density over the electrode is highly controllable and substantially uniform throughout its volume.

The second electrode 832 is formed to be substantially structurally similar to that of the first electrode 824, except for its smaller size. In a manner similar to that of the first electrode 824, the second electrode 832 is disposed within the second well 817. The second electrode 832 is formed to have a volume of material which is approximately the size of the second well 817. The second electrode 832 is bound by a conductive band 825, and is connected with a source of negative electric potential through a metal plug 810, and through the conductive band 825, which acts along the entire outer periphery of the second electrode 832. As a result, the second electrode 832 serves as a cathode.

In general, the asymmetric electrolytic cell 800 for electrolytic disinfection of the liquid being processed, and for regulation of the of the acidity and alkalinity of the liquid being processed, includes a housing 801 segmented into at least two asymmetric wells 816, 817. The wells are separated by an electrically neutral, porous membrane 809, an electrode 824, 832 is disposed within each well, at least one source of constant electric potential connected to the electrodes, and a covering is provided on the external surface of the electrodes 825, the covering providing a porous, elastic, nonmetallic woven contact for connection to a source of constant electric potential. The cell 800 further includes an input 803 for inputting of a metallic liquid into the volume of the electrode 824 connected to a source of positive electric potential, and an output 802 for outputting the processed liquid from the volume of the electrode 824 connected to a source of positive electric potential. In addition, the cell 800 further includes an input 805 for inputting of a metallic liquid into the volume of the electrode 832 connected to a source of negative electric potential, and an output 804 for outputting the processed liquid from the volume of the electrode 832 connected to a source of negative electric potential.

Referring now to FIG. 11, operation of asymmetric electrolytic cell 800 will now be described. In operation, the liquid Lᵢₙ to be treated and processed is forced to enter the first inlet opening 803 as a first laminar stream 902, and to enter the second inlet opening 805 as a second laminar stream 903. The liquid may be driven using conventional techniques, which may include using the influence of forces of gravitation, and/or pumping. In some embodiments, the housing 801 is disposed within an external tank 301 filled with the liquid to be treated, whereby the head of liquid above the first and second inlet openings 803, 805 generates the required driving force.

The first laminar stream 902 enters into the relatively large working volume of the positive electrode 824, and the second laminar stream 903 enters into the relatively small working volume of the negative electrode 832. Owing to the migration of the streams 902, 903 under the greater influence of the positive electric field whose volume is greater, much of the first laminar stream 902 remains within the working volume of the positive anode 824. In addition, a part of the second laminar stream 903 from the negatively charged second well 817 passes through the membrane 809 into the positively charged first well 816. These stream portions have their acidity increased, and exit through the first outlet opening 802 of the first well 816. If desired the treated liquid is collected in a tank (not shown) provided for that purpose.

Furthermore, a portion of the first laminar stream 902 enters into the negatively charged second well 817 through the membrane 809. In addition, a portion of the second laminar stream 903 remains within the second well 817 without ever passing through the membrane 809. These stream portions are provided with a higher level of alkalinity, and exit through the second outlet opening 804 of the second well 817. If desired the treated liquid is collected in another tank (not shown) provided for that purpose.

In order to achieve disinfection of a liquid to be treated Lᵢₙ, it is necessary that the level of acidity sharply increase in the volume of the liquid. An electrode connected to a source of positive electric potential has been shown to influence the level of acidity of a volume of liquid in which it has been placed. Thus, in the asymmetric electrolytic cell 800, when the electrode 824 having greater volume is connected to a source of positive electric potential, the level of acidity increases in the streams which pass through the active volume of the positively charged electrode. The increased level of acidity promotes destruction of all bacteria and microorganisms within those streams. Specifically, in the embodiment shown in FIG. 11, the stream of liquid exiting through the first outlet opening 802 of the first well 816 has been disinfected, while the stream of liquid exiting through the second outlet opening 804 of the second well 817 is at a level of higher alkalinity and is therefore returned to the original tank of unprocessed liquid and is reprocessed.

It should be appreciated that the disclosed apparatus 800 permits disinfection of liquids without requiring the addition of additional chemicals to the liquid. Similarly, the disclosed apparatus provides a means by which the pH level of a liquid can be controlled, for example within a process, without requiring the addition of additional chemicals to the liquid.

The asymmetric electrolytic cell 800 can also be used to control and/or alter the pH of a liquid for reasons other than disinfection. It should be appreciated that the disclosed apparatus provides a means by which the pH level of a liquid can be controlled, for example within a process, without requiring the addition of additional chemicals to the liquid.

Specifically, in order to increase the level of acidity in a liquid, the apparatus is used as described above, and the output of the first upper outlet opening 802 contains a liquid of increased acidity.

Alternatively, in order to increase the level of alkalinity in a liquid, the larger, first electrode 824 is connected to a source of negative electrical potential, and the smaller, second electrode 832 is connected to a source of positive electrical potential. As a result, the greater part of the volume of a liquid input into the cell housing 801 is affected by the negative electric potential and the level of alkalinity in it increases; and the smaller part of the volume of a liquid input into the cell housing 801 has a decreased alkalinity (an increase of acidity). In short, the process of increasing the level of alkalinity in a liquid using asymmetric electrochemical electrode cells is opposite to the process of increasing acidity in a liquid. Thus, in this example, the output of the first upper outlet opening 802 contains a liquid of increased alkalinity and is collected, and the output of second upper outlet opening 804 of the second well 817 is at a level of higher acidity, and is therefore is returned to the original tank of unprocessed liquid and is reprocessed.

It is understood that in use, an individual asymmetric electrolytic cell 800 can be employed, or a plurality of cells 800 can be employed, for example, by arranging the cells 800 in a module housing 301 within a processing system 350. It is understood, however, that the application of asymmetric electrolytic cell 800 is not limited to the processing system 350. For example, an alternative system 375 is illustrated in FIG. 16. In the system 375 for electrochemical alteration of pH of a liquid, a plurality of asymmetric electrode cells 800 are provided. The system 375 also includes an accumulation device 380 configured to gather and store the liquid to be processed. In this embodiment, the accumulation device includes a system of vessels 388. A collection device 382 is configured to collect the liquid from the accumulation device 380 and deliver the liquid into the asymmetric cells 800. After processing within the asymmetric cells 800, a delivery device 384, which is configured to gather altered liquid from the asymmetric cells, delivers the altered liquid to an appropriate storage location. Portions of the liquid having the desired level of pH, such as liquid output from the upper outlet opening 802 of the electrode having the greater volume, may typically be sent to an output storage device for storage. Portions of the liquid not having the desired level of pH, such as the liquid output from the upper outlet opening 804 of the electrode having the lesser volume may typically be recirculated to the accumulation device 380 for re-processing.

A method of altering the pH level within liquid solutions using electrochemical techniques will now be described. The method uses at least one electrolytic cell 800 and includes the following method steps:
Provide an asymmetric electrolytic cell 800 as described above.
Determine the desired level of pH for the output liquid.
Complete an electrical contact of the electrodes 824, 832 of an asymmetric electrolytic cell 800 to a source of constant electric potential 220. In this step, the electrodes include the active working volume and all active working surfaces of the electrodes.
Apply a constant electric potential on the asymmetric electrolytic cell 800 based on the desired level of pH for the output liquid. An increased acidity and/or disinfection of a liquid to be treated is obtained by connecting the larger electrode 824 of the electrode pair to a source of positive potential 201, and connecting the smaller electrode 832 of the electrode pair to a source of negative potential 204. An increased alkalinity of a liquid to be treated is obtained by connecting the larger electrode 824 of the electrode pair to a source of negative potential 204, and connecting the smaller electrode 832 of the electrode pair to a source of positive potential 201.
Create the directed stream of a liquid to be processed Lᵢₙ in the inlet openings 803, 805 of the cell 800. As discussed above, the liquid Lᵢₙ may be driven using conventional techniques, which may include using the influence of forces of gravitation, and/or pumping.
Form an ascending stream of a metallic liquid through the respective volumes of the charged electrodes 824, 832. This is achieved by locating the outlet openings 802, 804 of the electrode cell at a position above the inlet openings 803, 805. In order to maximize the ascending effect, the inlet openings 802, 804 are positioned adjacent a lower edge of the cell housing 801, and the outlet openings 803, 805 are positioned adjacent to an upper edge of the cell housing 801.
Electrically press liquids from the ascending stream in the charged larger electrode 824.
Output a first stream of liquid from the active working volume of the larger charged electrode 824 having the desired pH characteristics,
Output a second stream of liquid from the active working volume of the smaller, oppositely charged electrode 832. The second stream does not having the desired pH characteristics and thus may be recycle through the asymmetric electrolytic cell 800.

The method of altering the pH level of liquid solutions using the above asymmetric cell system can also include providing remote control of the electrochemical processes, wherein the remote control comprises using magnetic resonance sensors to measure a level of electric resistance of the liquid before electrochemical processing.

In each embodiment described herein, electrochemical processes are improved by employing electrodes formed of flexible, conductive fabric made from carbon, graphitic cotton wool, or from carbon composites. The fabric electrodes are covered with conductive band contacts made from composite carbon-carbon fabric, to provide an electrical connection between the electrodes and an electrical source. Such electrodes provide a porous electrode volume having a high current density which is substantially uniform across the electrode working volume. The electrodes are chemically inert and provide an enormous active surface area.

When a pair of such electrodes are used to form a cell having an electrode pair, the first and second electrode may have substantially the same volume, or may have substantially different volumes, whereby the application of symmetric and asymmetric variants of the design of the electrode cells is dependent upon the specific requirements of the particular electrochemical process to be used.

Although applications of the above approaches to electroextraction, electro-coagulation, and electrochemical alteration of pH of a liquid have been described, these applications are only illustrative in nature and thus are not limiting. Various design alterations may be carried out without departing from the present approaches as set forth in the claims.

1. (canceled)

2. (canceled)

3. (canceled)

4. (canceled)

5. (canceled)

6. An electrochemical reactor for processing a liquid solution, the reactor comprising:
a housing, the housing including a liquid inlet through which the liquid is directed into the housing, and a liquid outlet;
an electrically neutral membrane which partitions the housing into a first well and a second well, the membrane configured to electrically insulate a contents of the first well from a contents of the second well;
a first electrode comprising a first volume and extending into the first well; and
a second electrode comprising a second volume and extending into the second well,
wherein the first and second volumes are configured to permit fluid flow in a first direction, and in a second direction perpendicular to the first direction.

7. The reactor of claim 6 wherein the first volume is substantially the same as a volume of the first well, and wherein the second volume is substantially the same as a volume of the second well.

8. The reactor of claim 7, wherein the first volume is substantially the same as the second volume.

9. The reactor of claim 7, wherein the first volume is greater than the second volume.

10. The reactor of claim 6, wherein the first electrode and the second electrode are each formed of an electrically conductive fabric.

11. The reactor of claim 10, wherein
the first and second electrodes are adapted to be connected to a sources of electric potential, such that when a positive electrical potential is applied to the first electrode and a negative electrical potential is applied to the second electrode, a substantially uniform current density is provided across the respective first and second volumes, whereby when the liquid passes from the liquid inlet to the liquid outlet, an electrochemical reaction takes place in which metals in the liquid are deposited on at least one of the conductive members, and liquid exiting the liquid outlet is substantially free of metals.

12. The reactor of claim 10 wherein the first electrode and the second electrode are each formed of coal carbon wool pressed into a plate, the plate comprising plural folds such that the plate is configured into plural stacked layers, and wherein the plural stacked layers are wrapped in an electrically conductive band that surrounds, and is electrically conductive with, the outer periphery of the electrically conductive fabric.

13. A method of extraction of metals from a liquid that includes one or more metals in solution using an extraction device, the extraction device comprising
an electrode cell, and
a first electrode and a second electrode disposed within the electrode cell, the first and second electrode being physically and electrically separated by a porous, electrically neutral membrane,
the method comprising:
connecting the active working volume and an active working surface of the first electrode to a source of constant positive electric potential;
connecting the active working volume and an active working surface of the second electrode to a source of constant negative electric potential;
applying a constant electric potential to the electrode cell such that at least 90 percent of a respective active working volume of the electrodes of the electrode cell is provided with a source of substantially constant electric potential;
creating a directed stream of the liquid in an entrance channel of the electrode cell;
permitting the stream to flow within the active working volume of the first electrode;
pressing the stream from the active working volume of the first electrode through the membrane and into the active working volume of the second electrode;
permitting the stream to flow within the active working volume of the second electrode;
whereby a current density is created that is substantially uniform across the respective active working volumes of the first and second electrodes, and is capable of producing a high-speed process of electro-deposition of metal in the active working volume of the second electrode; and
outputting a stream of a processed liquid from the active working volume of the second electrode via an exit channel of the electrode cell.

14. The method of claim 13, wherein the liquid comprises a water solution.

15. The method of claim 13, wherein the step of applying a constant electric potential to the electrode cell comprises contacting at least 95 percent of the respective active working volume of the electrodes of the electrode cell.

16. The method of claim 13, wherein the step of applying a constant electric potential to the electrode cell comprises contacting substantially the entire respective active working volume of the electrodes of the electrode cell.

17. The method of claim 13, wherein the step of connecting the active working volume comprises connecting the entire active working volume and the entire active working surface of the respective first and second electrodes to the source of constant electric potential.

18. The method of claim 13, wherein the step of outputting a stream of a liquid from the active working volume of the second electrode comprises outputting a substantially metal-free stream of a liquid.

19. The method of claim 13, wherein the extraction device further comprises a magnetic resonance sensor, and wherein the method further comprises the step of
determining the density of the second electrode using the magnetic resonance sensor.

20. The method of claim 13, wherein density of the active working volume of the second electrode is determined based on measured electrical resistance of the second electrode.

21. The method of claim 13, wherein the extraction device further comprises magnetic resonance sensors, and wherein the method further comprises the step of:
providing remote control of the electrochemical processes,
wherein the remote control comprises using the magnetic resonance sensors to measure a level of electric resistance of the liquid before electrochemical processing.

22. The method of claim 13, wherein the extraction device further comprises magnetic resonance sensors, and wherein the method further comprises the steps of:
using the magnetic resonance sensors to monitor a level of electrical conductivity in the liquid before and after processing; and
regulating the electrical parameters of the electro-deposition processes based on the active working surface and the acting working volume of the second electrode and the metals contained in the liquid based on the monitored level of electrical conductivity.

23. A device for electrolytic extraction of metals from a liquid that includes one or more metals in solution, the device comprising:
a first electrode and a second electrode;
an electrically neutral, porous membrane disposed between the first and second electrodes;
a source of substantially constant positive electric potential connected to the first electrode;
a source of substantially constant negative electric potential connected to the second electrode;
a first porous, elastic, nonmetallic woven contact disposed to cover at least a portion of an external surface of the first electrode, the first contact being electrically connected to the source of the constant positive electric potential;
a second porous, elastic, nonmetallic woven contact disposed to cover at least a portion of an external surface of the second electrode, the second contact being electrically connected to the source of the constant negative electric potential;
an input device configured to input the liquid solution into a working volume of the first electrode;
an output device configured to output a processed liquid from a working volume of the second electrode.

24. The device of claim 23, wherein the liquid comprises a water solution.

25. The device of claim 23, wherein the membrane comprises a filtering fabric including polypropylene strings.

26-67. (canceled)
